(19) United States
(12) Patent Application Publication
(10) Pub. No.: US 2010/0068424 A1
(43) Pub. Date: Mar. 18, 2010

(54) DECORATION BOARD AND MANUFACTURE METHOD THEREOF

(75) Inventor: Chun-Xing Li, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/211,629

(22) Filed: Sep. 16, 2008

(51) Int. Cl. B29D 11/00; B44F 1/08

(52) U.S. Cl. 428/30; 264/1.34

(57) ABSTRACT

A decoration board and a manufacture method therefore are provided to generate different visible patterns on the decoration board from different viewing angles. The decoration board includes an outer surface and multiple stria structures disposed on the outer surface. Each stria structure includes multiple hairlines, wherein the stria structures are partially overlapped with one another to form multiple primary decoration regions and multiple secondary decoration regions. According to various overlapping frequency and overlapping shapes of the stria structures, the primary decoration regions and the secondary decoration regions generate different visible patterns under different viewing angles.

### BACKGROUND OF THE INVENTION

1. Field of the Invention

The present invention relates to a decoration board and its relevant manufacture method, in particular, to a decoration board applied to an electronic device and the relevant manufacture method thereof.

2. Related Art

Decoration board of electronic products may be designed through several manners as follows, so as to result in many different visual appearance variations.

The decoration board of certain electronic product is designed to be demountable, so the decoration board may be replaced as users like. However, the decoration board is replaced by dismounting and mounting, thus causing inconvenience for consumers in use. Therefore, a technique of changing a case by using light variation is proposed. For example, disposing several LED (Light Emitting Diode) elements onto the decoration board of a mobile phone. Under different situations, such as incoming call answering and short message sending, the LED elements may show different light colors according to different situations, thereby varying the color of the decoration board of the mobile phone. Further, an electrochromic technique is used, in which an electrochromic layer is disposed in the decoration board of the electronic product, and voltages with different values are conducted in the electrochromic layer, such that the electrochromic layer shows different colors, thereby varying the color of the case.

However, no matter the LED or the electrochromic technique is used in the decoration board variation in the conventional art, it is necessary to supply an additional power source, which results in additional power consumption. However, if the manner of replacing the decoration board by oneself is adopted, the pursuit of novelty and originality demanded by the user cannot be satisfied.

Therefore, an issue to be urgently solved is how to solve the problems resulting from the appearance variation of the decoration board in the conventional art.

### SUMMARY OF THE INVENTION

To solve the aforesaid problems of the prior art, the present invention provides a decoration board and the relevant manufacture method to form various visible patterns of multiple stria structures on the decoration board by means of different decoration frequency and/or overlapping shapes.

In an embodiment of the present invention, a decoration board comprises an outer surface and multiple of stria structures disposed on the outer surface. Each of the stria structures has multiple hairlines. The stria structures are partially overlapped with at least one another to form multiple primary decoration regions and multiple secondary decoration regions. Each of the primary decoration regions and each of the secondary decoration regions, according to an overlapping frequency and an overlapping shape of the overlapped stria structures, generate different visible patterns from different viewing angles.

In another embodiment of the present invention, a manufacturing method of a decoration board includes the following steps. First of all, provide an outer surface of the decoration board. Next, dispose multiple stria structures on the outer surface; each of the stria structures has multiple hairlines. Afterwards, partially overlap the stria structures with one another so as to generate multiple primary decoration regions and multiple secondary decoration regions. Each of the primary decoration regions and each of the secondary decoration regions, according to an overlapping frequency and an overlapping shape of the overlapped stria structures, generate different visible patterns from different viewing angles.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1A is a first schematic view of a decoration board according to a first embodiment;

FIG. 1B is a second schematic view of the decoration board according to the first embodiment;

FIG. 1C is a third schematic view of the decoration board according to the first embodiment;

FIG. 2A is a first schematic view of the decoration board according to a second embodiment;

FIG. 2B is a second schematic view of the decoration board according to the second embodiment;

FIG. 3A is a first schematic view of the decoration board according to a third embodiment;

FIG. 3B is a second schematic view of the decoration board according to the third embodiment;

FIG. 4A is a first schematic view of the decoration board according to a fourth embodiment;

FIG. 4B is a cross-sectional view of FIG. 4A;

FIG. 4C is a second schematic view of the decoration board according to the fourth embodiment;

FIG. 4D is a third schematic view of the decoration board according to the fourth embodiment;

FIG. 4E is a fourth schematic view of the decoration board according to the fourth embodiment;

FIG. 5A is a first schematic view of the decoration board according to a fifth embodiment;

FIG. 5B is a second schematic view of the decoration board according to the fifth embodiment;

FIG. 5C is a third schematic view of the decoration board according to the fifth embodiment;

FIG. 5D is a fourth schematic view of the decoration board according to the fifth embodiment; and

FIG. 6 is a flow chart of processes of a manufacturing method of the decoration board.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

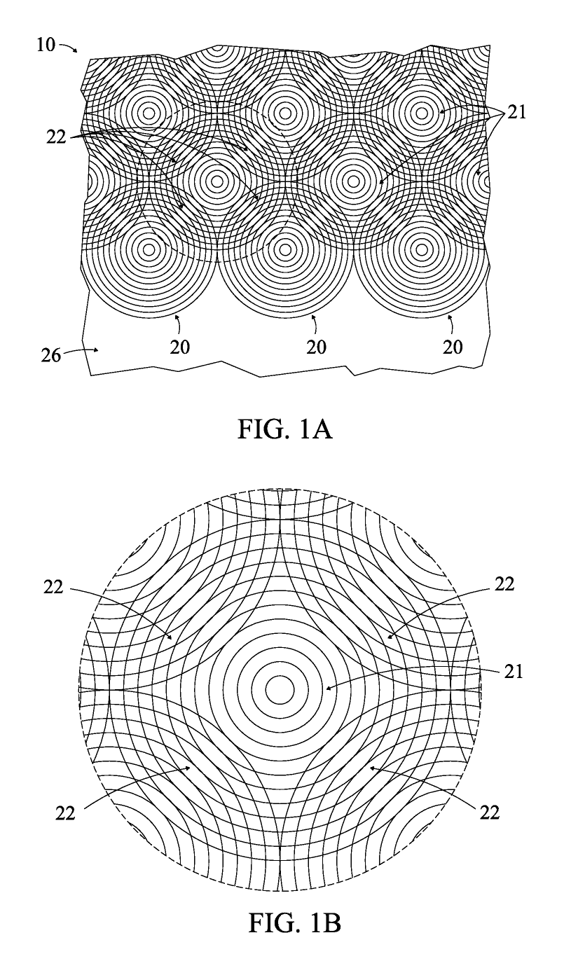

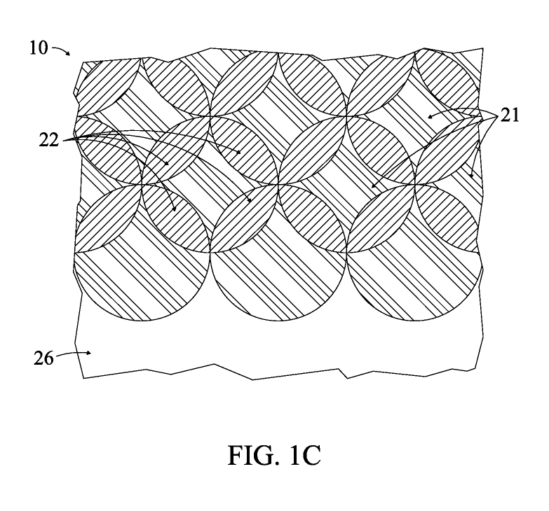

Referring to FIG. 1A, a first top view of a decoration board according to a first embodiment is shown. The decoration board includes an outer surface 10 and multiple stria structures 20 disposed on the outer surface 10. Such decoration board is used to cover onto an electronic apparatus as a part of the housing. For example, the decoration board may serve as a top cover of a notebook computer, configured onto the back side of its display panel.

As shown in FIG. 1, the stria structures 20 are disposed on the outer surface 10 of the decoration board, and each of the stria structures 20 includes multiple hairlines. The type of the hairlines can be actually hair-thin lines. The stria structures 20 may be sunken structures generated by grinding the outer surface 10, or raised structures generated by printing ink materials on the outer surface 10. The type of stria structures 20 is determinable according to the required appearance effect of the decoration board or the machining method of the decoration board. Various types of stria structures 20 will be further disclosed in below sections. As shown in FIG. 1, these stria structures 20 are partially overlapped with one another to form multiple primary decoration regions 21 and multiple secondary decoration regions 22 on the outer surface 10.

Referring to FIG. 1B, an enlarged partial view of the decoration board according to the first embodiment is shown. The primary decoration region 21 of the first embodiment is enlarged in FIG. 1B. As shown in FIG. 1B, the shape of the primary decoration region 21 the first embodiment is a rhombus, but the shape of the primary decoration region 21 is not limited to a rhombus. The rhombus-shaped regions are the regions in which the stria structures 20 are grinded or printed only once in the plurality of partially overlapped stria structures 20. That is, a rhombus-shaped region is the non-overlapped portion in the plurality of stria structures 20.

Referring to FIG. 1C, a top view of another decoration board according to the first embodiment is shown. The secondary decoration regions 22 of the first embodiment are particularly emphasized in FIG. 1C. As shown in FIG. 1C, the shape of the secondary decoration regions 22 of the embodiment is spindle-shaped, and each of the stria structures 20 has four secondary decoration regions 22, that is, four spindle-shaped regions, but the shape of the secondary decoration region 22 is not limited to spindle-shaped. In FIG. 1C, the primary decoration regions 21 and the secondary decoration regions 22 are filled with different cross-section lines, so as to clearly show that the primary decoration regions 21 are rhombs, and the secondary decoration regions 22 are spindles. The regions forming the spindles are the regions in which the stria structures 20 are grinded or printed twice in the plurality of partially overlapped stria structures 20. That is to say, the spindle region is the portion at which two stria structures 20 are overlapped with each other, i.e., the regions in which the stria structures 20 are overlapped twice.

Basically in the present invention, visible patterns generated by the stria structures will vary with a decoration frequency (such as an overlapping frequency) and overlapping shapes. Referring to FIG. 1A, each of the primary decoration regions 21 and secondary decoration regions 22 generates different visible patterns from different viewing angles according to overlapping frequency and overlapping shapes of the stria structures 20, which will be described in detail thereafter. Here, the so-called patterns include, but not limited to, edge, shape, hairline density, hairline thickness formed by the stria structures 20.

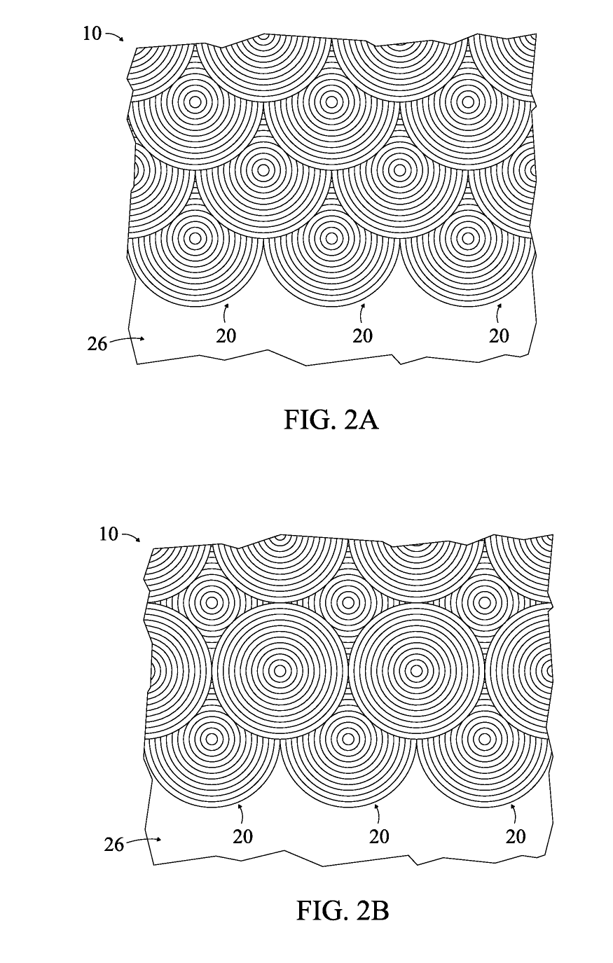

Referring to FIGS. 2A and 2B, first and second schematic views of the decoration board according to a second embodiment are shown. In the second embodiment, the patterns generated from different viewing angles are defined by a decorating sequence of the stria structures 20. Here, the so-called decorating sequence is the sequence of disposing each stria structure 20, that is, the sequence of grinding or printing each stria structure 20 on the outer surface 10. It may be clearly found in FIGS. 2A and 2B that as long as the decorating sequence is varied, even for the same stria structure 20, the different visible patterns may be generated, thus generating a visually different effect.

Further, at least one of the decoration board and the stria structure 20 may be made of a reflective material. Therefore, with the variation of the reflective material due to the light ray reflection (refraction), and the overlapping frequency and the overlapping shapes of the primary decoration regions 21 and the secondary decoration regions 22 generated by partially overlapping the stria structures 20, it is possible to generate more abundant and variable patterns from different viewing angles. For the gloss of the overlapping positions of the stria structures 20, for example, more overlapping frequency means more grinding or printing times, and results in darker gloss of the region with more overlapping frequency when being viewed from the front. However, because of the reflective material, from other angles, the region with more overlapping frequency may have a brighter gloss. Therefore, the gloss of the overlapping position of the stria structure 20 may be varied according to different overlapping frequency and viewing angles.

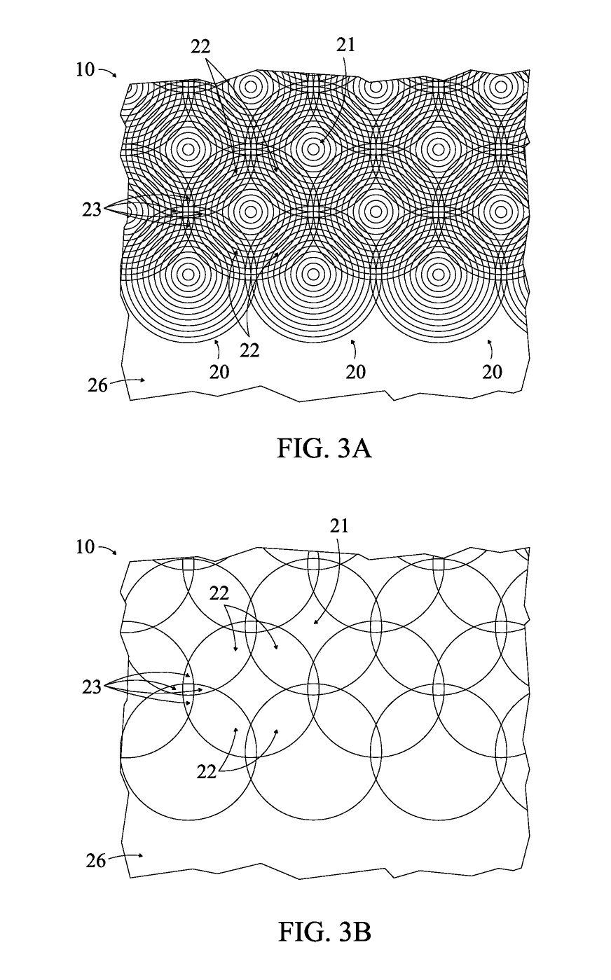

Referring to FIGS. 3A and 3B, first and second schematic views of the decoration board according to a third embodiment are respectively shown. In the third embodiment, the stria structures 20 further generate at least one additional decoration region. In the above description, the stria structures 20 generate the primary decoration regions 21 and the secondary decoration regions 22, but in practice, more different decoration regions may be generated through the variation of the overlapping frequency and the overlapping shapes of the stria structures 20, which are called the additional decoration regions in the present invention. Each additional decoration region has one decoration frequency. The primary decoration regions 21 and the secondary decoration regions 22 are mentioned above, so the decoration frequency of the additional decoration region is an integral times larger than or equal to three, and different decoration frequency correspond to different visible patterns. As shown in FIG. 3A, in addition to the primary decoration regions 21 in a rhomb shape and the secondary decoration regions 22 in a spindle shape, there is a new pattern in the drawing, i.e., tertiary decoration regions 23 approximately in a cross shape. The stria structure 20 of FIG. 3A has multiple hairlines, such that the drawing is relatively complicated. For the convenience of description and the emphasis of the tertiary decoration regions 23, the hairlines are simplified in FIG. 3B, so as to clearly know that the tertiary decoration region 23 is approximately in the cross shape. Further, in addition to the tertiary decoration regions 23, by varying the overlapping frequency and the overlapping shapes of the stria structures 20, quaternary, quinary, and senary decoration regions with different visible patterns may be further generated, such that the decoration board of the present invention may generate more different visible patterns from different viewing angles.

Referring to FIG. 1A, it may be known from the drawing that each stria structure 20 includes multiple concentric circles. That is to say, multiple concentric circles form each stria structure 20. In certain implementation, each concentric circle (the hairline) may be a reflecting line. For sunken type of stria structures 20, the “reflecting” appearance may be generated by grinding the outer surface 10 of a “metal” decoration board with coarse abrasive materials. Grinded metal shines. Grinded metal shines. For raised type of stria structures 20, the “reflecting” appearance may be generated by printing the outer surface 10 with high reflection-coefficient ink materials.

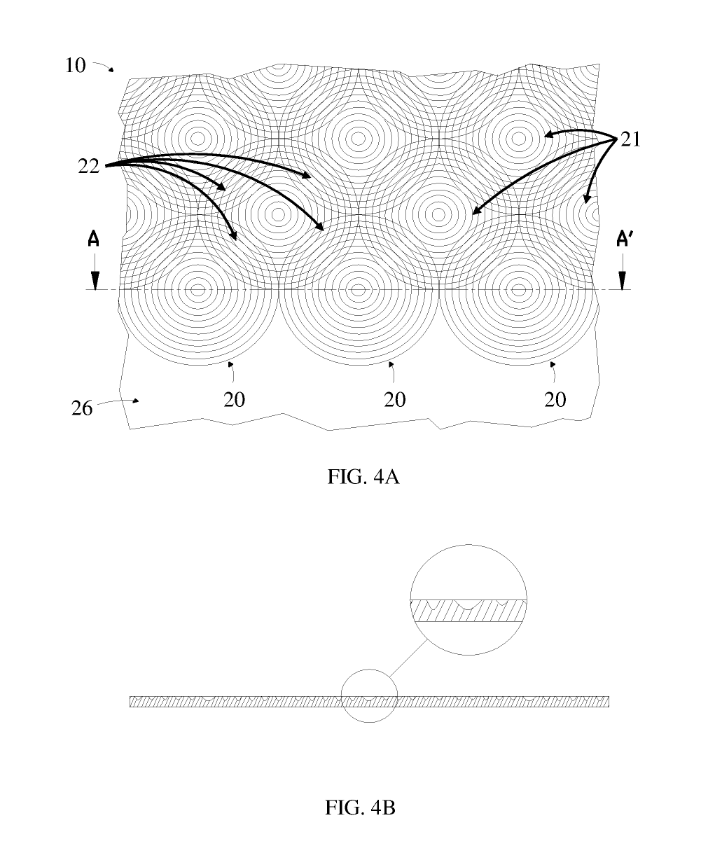

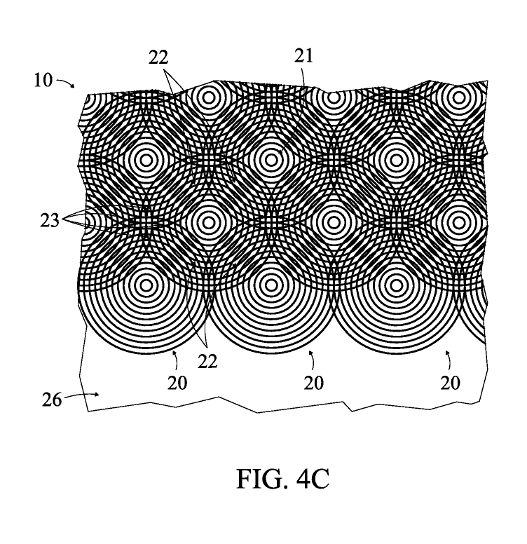

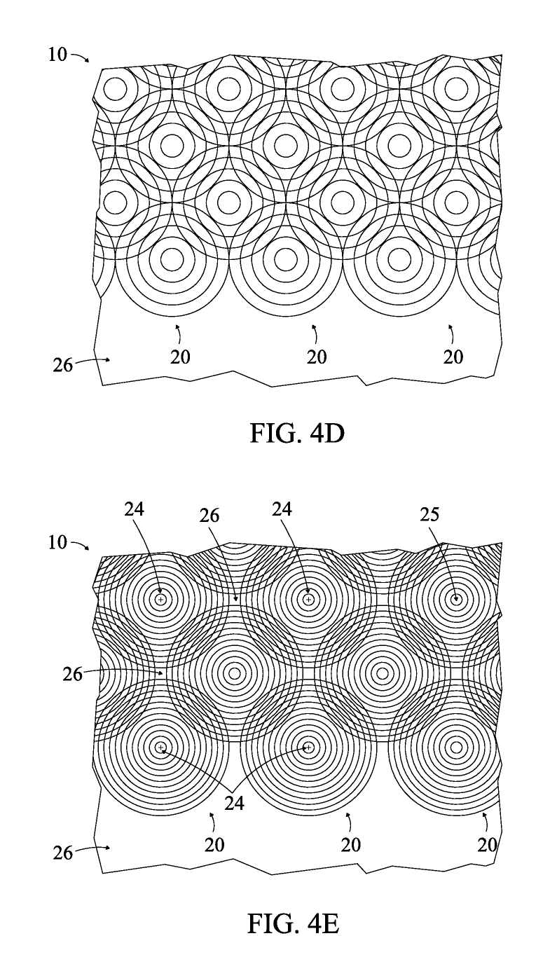

The concentric circles are further described herein below. Firstly, referring to FIGS. 4A and 4B, a cross-sectional view taken along an AA′ line segment in FIG. 4A is shown in FIG. 4B. It may be found from FIG. 4B that depths of lines of the concentric circles are different. In order to achieve the different depths of the lines of the concentric circles, for the stria structure 20 generated by grinding, the grinding pressure may be varied to achieve the different depths of the lines of the concentric circles. The larger grinding pressure may generate deeper depth of the line of the concentric circle; oppositely, the smaller grinding pressure may generate shallower depth of the line of the concentric circle, thereby varying the patterns generated by the stria structures 20.

Referring to FIG. 4C, a second schematic view of the decoration board according to the fourth embodiment is shown. It may be found from the comparison between FIGS. 4C and 3A that widths of the lines of the concentric circles of the two drawings are different. Here, during the grinding, sizes of grinding particles may be varied, so as to achieve different widths of the lines of the concentric circles, thereby varying the patterns generated by the stria structures 20.

Further, through the different pitches of the concentric circles, the patterns generated by the stria structures 20 may be varied. Referring to FIG. 4D, a third schematic view of the decoration board according to the fourth embodiment is shown. It may be found from the comparison between FIGS. 4D and 1A that the pitch of the concentric circles in FIG. 4D is distinctly larger than that of FIG. 1A. Here, during the grinding, the density relation of the arrangement of the grinding particles may be varied, thereby achieving different pitches of the concentric circles.

Referring to FIG. 4E, a fourth schematic view of the decoration board according to the fourth embodiment is shown. Here, the center points of the stria structures may be arranged in a polygon. As shown in the drawing, the center points 24 of the stria structures 20 are arranged in rectangles, but the present invention is not limited here. It may be found from FIG. 4E that a circular non-decorated region 25 is disposed at the center of the stria structure 20. It is assumed that the decoration board is made of the reflective material, and the circular non-decorated region 25 may generate a bright spot on the decoration board, such that the whole decoration board has multiple bright spots, thereby forming another special pattern.

Referring to FIG. 4E, it may be known from the drawing that a non-decorated region 26 is disposed among four stria structures 20, and the non-decorated region 26 in the drawing is approximately a rectangle, but the present invention is not limited here. Similarly, it is assumed that the decoration board is made of the reflective material. In this manner, when the non-decoration region 26 is disposed among the plurality of stria structures 20, the reflecting regions on the decoration board assume various different shapes, so as to form another special pattern. Here, the non-decorated region 26 is not limited to be formed by four stria structures 20, and may be formed by different numbers of stria structures 20 according to the pattern requirements, but the number of the stria structure 20 must be at least more than three (including three).

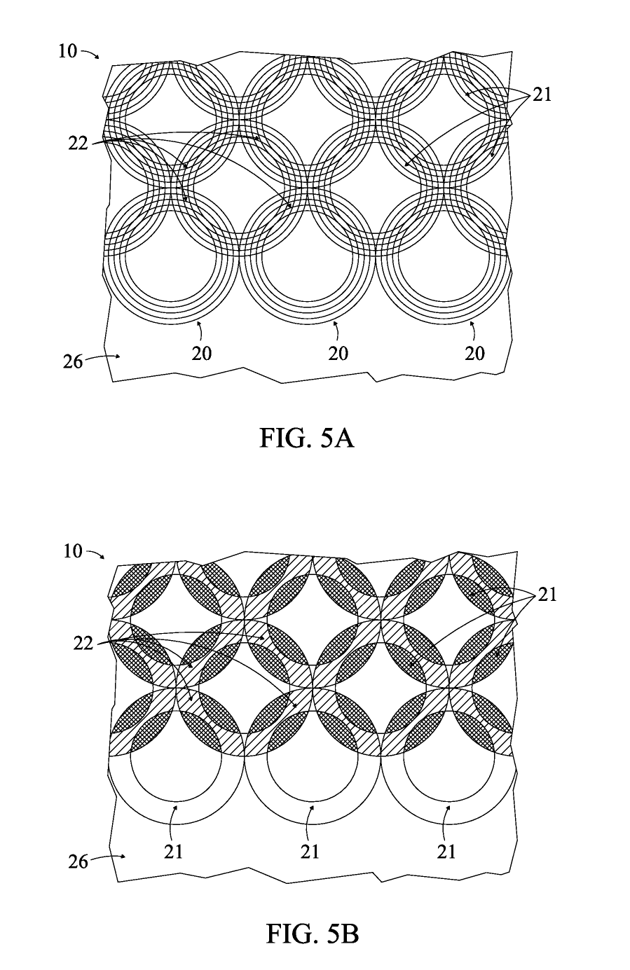

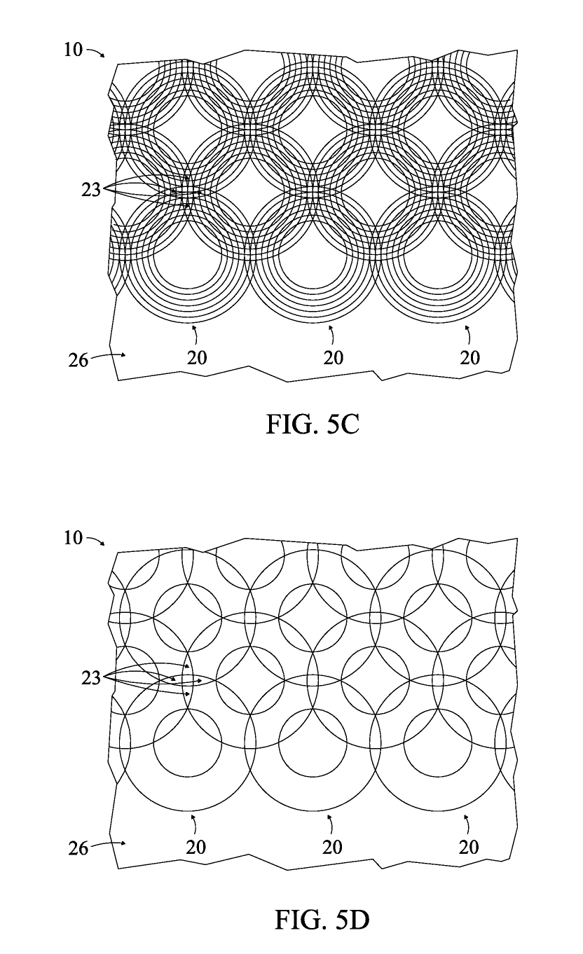

Referring to FIGS. 1A and 5A, the concentric circles of the stria structures 20 in FIG. 1A form a visually-solid circle, and the so-called visually-solid circle is the region formed by the outmost concentric circle in the stria structure and the center point, in which multiple concentric circles are disposed. The concentric circles of the stria structure 20 in FIG. 5A form an annular region, and the difference between the two may be found after the two circles are compared.

Referring to FIGS. 5A to 5D, in this embodiment, the concentric circles form the annular regions, so as to generate multiple different visible patterns, and several patterns are listed in the drawings for description instead of limitation. In FIG. 5B, the primary decoration regions 21 and the secondary decoration regions 22 are introduced and differentiated by different cross-section lines, so as to clearly know the difference between the shapes of the primary and the secondary decoration regions. It may be known from FIG. 5B that the primary decoration region 21 is a spindle, and one stria structure 20 has eight primary decoration regions 21, that is, eight spindles. The secondary decoration region 22 is approximately in a shape surrounded by two hyperbolas, and one stria structure 20 has four secondary decoration regions 22. The annular regions formed by the concentric circles may generate various different visible patterns. Referring to FIGS. 5C and 5D, it is known from FIG. 5C that the tertiary decoration region 23 is approximately in a cross shape; here, FIG. 5C is simplified to emphasize the tertiary decoration region 23. In FIG. 5D, the hairlines of the stria structures 20 are simplified, so as to clearly know that the tertiary decoration region 23 is approximately in the cross shape.

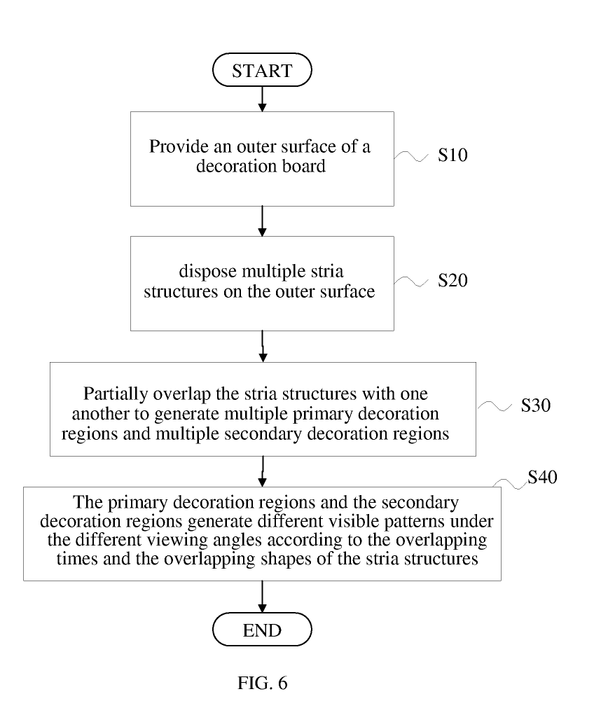

Referring to FIG. 6, a flow chart of processes of a manufacturing method of the decoration board is shown. All the following steps are also disclosed and mentioned in the descriptions and explanations above.

In Step S10, provide an outer surface of a decoration board. Such decoration board is used to cover onto an electronic apparatus as a part of the housing. For example, the decoration board may serve as a top cover of a notebook computer, configured onto the back side of its display panel.

In Step S20, dispose multiple stria structures on the outer surface, in which each stria structure includes multiple hairlines. The stria structures may be sunken structures generated by grinding the outer surface, or raised structures generated by printing ink materials on the outer surface. The type of stria structures is determinable according to the required appearance effect of the decoration board or the machining method of the decoration board. Basically in the present invention, visible patterns generated by the stria structures will vary with a decoration frequency (such as an overlapping frequency) and overlapping shapes. Yet sometimes the decoration frequency is not always the same as the overlapping frequency. The decoration frequency in the present invention is defined as how many times the decoration board is decorated, namely how many times of decoration processes are applied to the decoration board. A specific stria structure is possible to be overlapped only once (the overlap frequency is one) by another stria structure after four times of decoration processes (the decoration frequency is four).

In certain cases, multiple concentric circles (namely the hairlines of the present invention) may be disposed to form the stria structure. For raised type of stria structures, it is possible to print out concentric circles with same intervals and form a set of neat concentric circles. For sunken type of stria structures, one or more spin-type grinding head with coarse abrasive materials mounted thereon will be used to grind on the outer surface of the decoration board and generate concentric circles. If the abrasive materials on the grinding head have high uniformity, it is still possible to form a set of neat concentric circles. When less-uniform abrasive materials are used on the grinding head, the concentric circles in a set will have different intervals. However, if the density of the abrasive materials is high enough, and the hairline generated by grinding is relatively much smaller, a set of neat concentric circles may still be manufactured by the grinding process.

In the grinding or printing process, the stria structure may be formed one by one; namely, only one stria structure is formed by using the grinding/printing process once. A row of grinding/printing heads is also possible to be applied onto the decoration board. The sequence of printing out the stria structures will determine which stria structure is covered by another. On the contrary, the sequence of grinding to form the stria structures will determine which stria structure is partially grinded again by another.

One practical option for each concentric circle, namely the hairline, may be a reflecting line. For sunken type of stria structures, the “reflecting” line may be generated by grinding the outer surface of a “metal” decoration board with coarse abrasive materials. Grinded metal shines. Grinded metal shines. For raised type of stria structures, the “reflecting” appearance may be generated by printing the outer surface with high reflection-coefficient ink materials.

The step of providing the plurality of concentric circles may further include a step of providing the concentric circles with different depths of the lines. Optionally, the concentric circles with different widths of the lines, or the concentric circles with different pitches may be provided.

Here, the method may further include the step as follows. The stria structures are arranged such that the center points of the stria structure assume a polygon. Alternatively, the circle non-decorated region is disposed at the center of at least one of the stria structures. Alternatively, the non-decorated region is disposed among at least three of the stria structures.

As for the shapes formed by the concentric circles, the concentric circles of the stria structures may form the visually-solid circle or the annular region.

In Step S30, partially overlap the stria structures with one another to generate multiple primary decoration regions and multiple secondary decoration regions. At least one of the decoration board and the stria structure is made of the reflective material. In addition to generating the primary and the secondary decoration regions, the method further includes the step as follows. At least one additional decoration region is generated. Each additional decoration region has one decoration frequency, and the decoration frequency is an integral times larger than or equal to three, and each decoration frequency corresponds to a different visible pattern.

In Step S40, the primary decoration regions and the secondary decoration regions generate different visible patterns under the different viewing angles according to the overlapping frequency and the overlapping shapes of the stria structures. Here, the primary and the secondary decoration regions may also generate different visible patterns from the different viewing angles according to the decorating sequence of the stria structure.

In addition, the stria structures may be sunken structures generated by grinding or raised structures generated by printing.

In addition to the above steps, it is possible to vary the gloss of the overlapping positions of the stria structures according to the different overlapping frequency and viewing angles of the stria structures.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A decoration board, comprising:
an outer surface; and
a plurality of stria structures disposed on the outer surface, each of the stria structures comprising a plurality of hairlines;
wherein the stria structures are partially overlapped with at least one another to form a plurality of primary decoration regions and a plurality of secondary decoration regions;
wherein each of the primary decoration regions and each of the secondary decoration regions, according to an overlapping frequency and an overlapping shape of the overlapped stria structures, generate different visible patterns from different viewing angles.

2. The decoration board as claimed in claim 1, wherein the visible patterns, generated by the primary and the secondary decoration regions from different viewing angles, are defined by a decorating sequence of the stria structures.

3. The decoration board as claimed in claim 1, wherein the stria structures further comprises at least one additional decoration region with a decoration frequency that is an integral equal to or greater than three, thereby the visible pattern varies with the decoration frequency.

4. The decoration board as claimed in claim 1, wherein at least one of the decoration board and the stria structure is made of a reflective material.

5. The decoration board as claimed in claim 1, wherein each stria structure comprises a plurality of concentric circles.

6. The decoration board as claimed in claim 5, wherein center points of the stria structures are arranged in a polygon.

7. The decoration board as claimed in claim 5, wherein a circular non-decorated region is disposed in a center of at least one of the stria structures.

8. The decoration board as claimed in claim 5, wherein a non-decorated region is disposed among at least three of the stria structures.

9. The decoration board as claimed in claim 5, wherein the concentric circles of the stria structure form an annular region.

10. The decoration board as claimed in claim 1, wherein the stria structure is a sunken structure generated by grinding, or a raised structure generated by printing.

11. A manufacturing method of a decoration board, comprising the steps of:
providing an outer surface of the decoration board;
disposing a plurality of stria structures on the outer surface, each of the stria structures comprising a plurality of hairlines; and
partially overlapping the stria structures with at least one another so as to generate a plurality of primary decoration regions and a plurality of secondary decoration regions;
wherein each of the primary decoration regions and each of the secondary decoration regions, according to an overlapping frequency and an overlapping shape of the overlapped stria structures, generate different visible patterns from different viewing angles.

12. The method as claimed in claim 11, wherein the step of generating different visible patterns from different viewing angles comprises:
generating different visible patterns from different viewing angles according to a decorating sequence of the stria structures.

13. The method as claimed in claim 11, wherein the step of generating the primary and the secondary decoration regions comprises:
generating at least one additional decoration region with a decoration frequency that is an integral greater than or equal to three, thereby the visible pattern varies with the decoration frequency.

14. The method as claimed in claim 11, wherein the step of disposing the stria structures comprises:
providing a plurality of concentric circles so as to form each of the stria structures.

15. The method as claimed in claim 14, further comprising:
arranging the stria structures such that center points of the stria structures are arranged in a polygon.

16. The method as claimed in claim 14, further comprising:
defining a circular non-decorated region in a center of at least one of the stria structures.

17. The method as claimed in claim 14, further comprising:
defining a non-decorated region among at least three of the stria structures.

18. The method as claimed in claim 14, further comprising:
forming an annular region by the concentric circles of the stria structure.

19. The method as claimed in claim 11, wherein the step of disposing the stria structures comprises:
forming the stria structures with sunken structures generated by grinding;
or forming the stria structures with raised structures generated by printing.

20. The method as claimed in claim 11, wherein at least one of the decoration board and the stria structure is made of a reflective material.
